(19) United States
(12) Patent Application Publication
(10) Pub. No.: US 2025/0226850 A1
(43) Pub. Date: Jul. 10, 2025

(54) BI-DIRECTIONAL INPUT/OUTPUT (I/O) BANDWIDTH ENHANCEMENT

(71) Applicant: Micron Technology, Inc., Boise, ID (US)

(72) Inventors: Ming-ta Hsieh, Woodbury, MN (US); Nathan D. Henningson, Minneapolis, MN (US)

(21) Appl. No.: 18/827,536

(22) Filed: Sep. 6, 2024

Related U.S. Application Data
(60) Provisional application No. 63/619,138, filed on Jan. 9, 2024.

(51) Int. Cl. H04B 1/58

(52) U.S. Cl. CPC H04B 1/586

(57) ABSTRACT

Systems, methods and apparatus are provided for bi-directional I/O bandwidth enhancement via capacitive reactance reduction. An example apparatus can comprise a first signal driver of a transceiver, a second signal driver of the transceiver, an input/output (I/O) pad, and a y-coil, wherein the y-coil includes a first inductor coupled to the first signal driver of the transceiver, a second inductor coupled to the second signal driver of the transceiver, and a third inductor coupled to the I/O pad.

### PRIORITY INFORMATION

This application claims the benefit of U.S. Provisional Application No. 63/619,138, filed on Jan. 9, 2024, the contents of which are incorporated herein by reference.

### TECHNICAL FIELD

The present disclosure relates generally to electronic apparatuses and methods, and more particularly, to apparatuses and methods for bi-directional I/O bandwidth enhancement.

### BACKGROUND

Electronic apparatuses (e.g., devices and systems) include various integrated circuits (ICs) (e.g., chips) such as microprocessors, controllers, memory devices, field programmable gate arrays (FPGAs), application specific integrated circuits (ASICs), and system-on-a-chip (SoC) integrated circuits, among various other types of digital and/or analog integrated circuits. Various ICs include input/output (I/O) circuitry that can provide an interface between ICs (e.g., to send and/or receive signals). Accordingly, I/O circuitry often includes a physical pin through which signals (e.g., data) can be communicated (e.g., transmitted and/or received). As such, in some instances, the term “I/O pin” can be used to refer to the physical pin as well as additional I/O circuitry (e.g., transmit driver circuitry, receiver driver circuitry, etc.) coupled thereto. I/O circuits configured to both transmit and receive signals are referred to as bidirectional I/Os, and I/O circuits configured to only transmit signals or only receive signals are referred to as unidirectional I/Os.

### BRIEF DESCRIPTION OF THE DRAWINGS

FIG. 1 is a block diagram of an apparatus in the form of a portion of an electronic system for reducing capacitive reactance in accordance with a number of embodiments of the present disclosure.

FIG. 2 is a block diagram illustrating an example I/O component for reducing capacitive reactance in accordance with a number of embodiments of the present disclosure.

FIG. 3 is a flow diagram of a method for reducing transceiver capacitive reactance in accordance with a number of embodiments of the present disclosure.

### DETAILED DESCRIPTION

Systems, methods and apparatus are provided for bi-directional I/O bandwidth enhancement via capacitive reactance reduction. An example apparatus can comprise a first signal driver of a transceiver, a second signal driver of the transceiver, an input/output (I/O) pad, and a y-coil, wherein the y-coil includes a first inductor coupled to the first signal driver of the transceiver, a second inductor coupled to the second signal driver of the transceiver, and a third inductor coupled to the I/O pad.

In a bidirectional I/O component, transceivers (e.g., transmitter, receiver, etc.) are attached to the same I/O pad. The transceivers are attached to the I/O pad via signal paths that can include signal lines (e.g., wires), termination resistors, and/or electrostatic discharge (ESD) elements, among other elements, which can add capacitive reactance to an I/O component. In some previous approaches, in order to reduce I/O component capacitive reactance, circuit layout optimization including Tcoils can also be added to the I/O component to differentiate capacitive reactance from the pad and the signal drivers and to strengthen signal integrity. However, these approaches do not aid reducing undesirable impact on one signal driver (e.g., the receiver of a transmitter/receiver pair, which can be referred to as a receiver) from capacitive reactance of a different signal driver (e.g., the transmitter of the transmitter/receiver pair, which can be referred to as a transceiver).

Aspects of the present disclosure address the above and other challenges associated with reducing bidirectional I/O component capacitive reactance. In embodiments of the present disclosure, a y coil can be included in the I/O circuit. The y coil can include inductors (e.g., a first inductor and a second inductor) that are configured to reduce capacitive reactance on a signal path between a transceiver and the I/O pad and also include inductors (e.g., a first inductor and a third inductor) that are configured to reduce capacitive reactance on signal path between a receiver and the I/O pad. The y coil can be configured such that the inductors of the y coil are sized to provide a reduction in capacitive reactance on the signal paths of the I/O component such that the I/O component can provide particular desired bandwidth metrics for the I/O component.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. Further, as used herein, the term “decrease”, “reduce”, and/or “lower” (or the like) can be interchangeably used to indicate the same meaning.

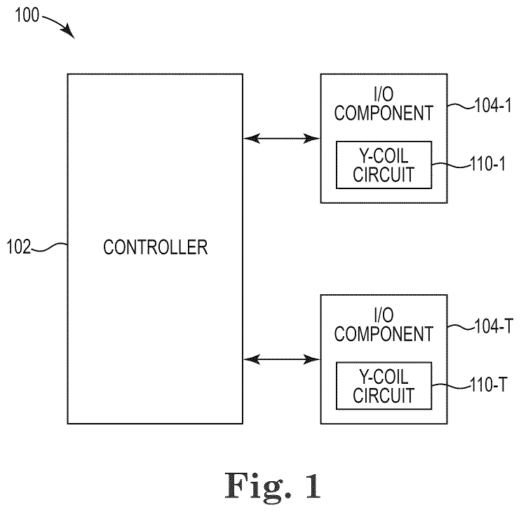

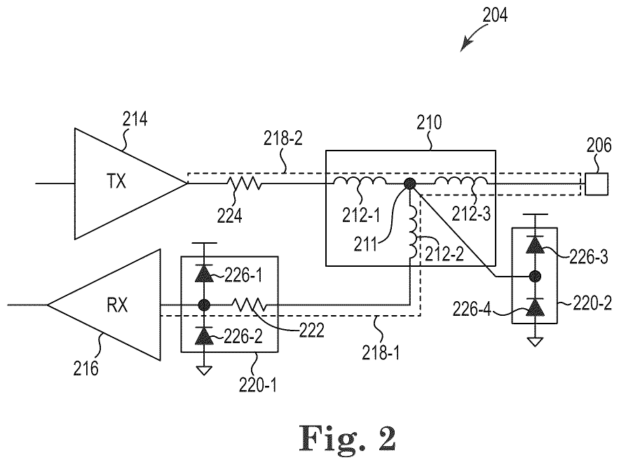

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

Analogous elements within a Figure may be referenced with a hyphen and extra numeral or letter. See, for example, elements 104-1, . . . , 104-T in FIG. 1. Such analogous elements may be generally referenced without the hyphen and extra numeral or letter. For example, elements 104-1, . . . , 104-T can be collectively referenced as 104. As used herein, the designators “T”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a portion of a computing system 100 including a controller 102 and input/output (I/O) components 104-1, . . . , 104-T (collectively referred to as “I/Os 104”) in accordance with a number of embodiments of the present disclosure. As used herein, a controller 102 and I/Os 104 might also be separately considered an “apparatus.”

The I/Os 104 can include various circuitry to facilitate transmission of signals between electrical components (e.g., chips). For example, I/Os 104 can include one or more signal paths include conductive signal lines, transceivers (e.g., transmitter, receiver, etc.), I/O pads, etc. that can receive an external signal (e.g., signal received from an external device, such as controller 102) and/or output the received signal (e.g., to the controller 102). Although embodiments are not so limited, I/O 104 can be a bidirectional I/O that can transmit/receive signals from/to an I/O pad.

Although embodiments are not so limited, I/Os 104 can form various buses (e.g., data buses, address buses, command buses, etc.) and can be placed in various locations of the computing system. For example, I/O components can be placed among peripheral devices (e.g., sensors, actuators, displays, etc.), a host (e.g., a desktop computer, laptop computer, network server, mobile device, or such computing device that includes a memory and a processing device), storage system (e.g., including memory dice) etc. of the computing system.

In some embodiments, one or more of I/Os 104 can be part of (e.g., form) a “port”, which may be a physical port, such as serial advanced technology attachment (SATA) ports, peripheral component interconnect express (PCIe) ports, universal serial bus (USB) ports, Fibre Channel ports, Small Computer System Interface (SCSI) ports, Serial Attached SCSI (SAS) ports, a dual in-line memory module (DIMM) ports, an NVM Express (NVMe) ports, Open NAND Flash Interface (ONFI) ports, etc. Further, in some embodiments, I/Os 104 can be (e.g., integrated) part of the controller 102 instead of being separate components independently of the controller 102.

I/Os 104 can include electromechanical switches that can be respectively (e.g., placed on signal lines) coupled to transceivers of I/Os 104. Electromechanical switches can be MEMS switches.

Controller 102 can include various circuitry to facilitate controlling various parts of the I/Os 104. For example, the controller 102 can include special purpose circuitry in the form of an ASIC, FPGA, state machine, and/or other logic circuitry or software and/or firmware that can allow the controller 102 to control parts of the I/Os 104, such as electromechanical switches.

In some embodiments, the controller 102 can be a device (e.g., testing equipment) that can control parts of the I/Os 104 during manufacturing and testing phases. In some embodiments, the controller 102 can be a device (e.g., of a computing device) that can control parts of the I/Os 104 during operation of the computing device. For example, the controller 102 can provide signals to I/Os 104 to configure I/Os to receive signals or transmit signals received thereto to an external circuit (e.g., off-chip), which can be done by selectively enabling/disabling electromechanical switches of I/Os 104.

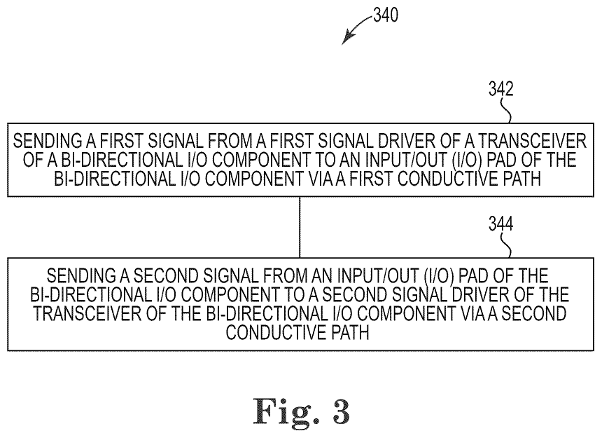

Also, as further illustrated in FIGS. 2-3, the I/Os 104 can include various circuitry to facilitate reducing transceiver capacitive reactance. For example, the I/Os 104 can include y-coil circuits 110-1, . . . , 110-T (collectively referred to as “y-coil circuits 110”). The y-coil circuits 110 can include a plurality of inductors, which can be configured to reduce the capacitive reactance on signal paths between signal drivers and an I/O pad. As further illustrated in FIGS. 2-3, each I/O component 104 can include a y-coil circuit with three inductors, a first inductor coupled between the I/O pad and a center tap, a second inductor coupled between the center tap and a first signal driver, and a third inductor coupled between the center tap and a second signal driver. The inductors can be configured to reduce the capacitive reactance on the signal paths of the I/O component based on the components (e.g., resistors and/or ESD circuits) along the signal paths of the I/O component.

FIG. 2 is a block diagram illustrating an example I/O component 204 (alternatively referred to as “I/O 204”) for reducing capacitive reactance in accordance with a number of embodiments of the present disclosure. I/O component 204 can include a first signal driver of a transceiver (e.g., a transmitter 214 shown as “TX” in FIG. 2), a second signal driver of the transceiver (e.g., a receiver 216 shown as “RX” in FIG. 2). As used herein, the term ‘transceiver’ generally refers to an input signal driver (e.g., a receiver) or an output signal driver (e.g., a transmitter) of an I/O component. Further, as used herein, the term “transmitter” can be alternatively referred to as “transmit driver”, “output signal driver”, etc. Further, the term “receiver” can be alternatively referred to as “receiver driver”, “input signal driver”, etc. As illustrated in FIG. 2, the transmitter 214 as an output signal driver is operable to drive a signal (e.g., received externally) to an I/O pad (e.g., I/O pad 206) and while the receiver 216 as an input signal driver is operable to drive a signal received from the I/O pad, such as I/O pad 206. A y-coil circuit 210 can be connected to the I/O pad 206 to differentiate capacitive reactance from the I/O pad 206 and the signal drivers 214, 216 and to strengthen signal integrity. Y-coil circuit 210 can include inductors 212-1, 212-2, and 212-3. Each of the inductors 212-1, 212-2, and 212-3 are coupled to center tap 211. Electrostatic discharge (ESD) component 220-2 comprising diode 226-3 and 226-4 can be coupled to center tap 211, and the capacitive reactance of ESD component 220-2 can be reduced by the y-coil circuit 210.

I/O component 204 can include signal path 218-1 between receiver 216 and I/O pad 206. Signal path 218-1 can include electrostatic discharge (ESD) component 220-1 comprising resistor 222 and diodes 226-1 and 226-2, electrostatic discharge (ESD) component 220-2 comprising diode 226-3 and 226-4 coupled to center tap 211, and inductors 212-2 and 212-3 of y-coil component 210. Inductors 212-2 and 212-3 on signal path 218-1 can be configured to reduce capacitive reactance on signal path 218-1 such that signals sent on signal path 218-1 between I/O pad 206 and receiver 216 can meet particular bandwidth metrics for the I/O component 204.

I/O component 204 can include signal path 218-2 between transmitter 214 and I/O pad 206. Signal path 218-2 can include termination resistor 224, electrostatic discharge (ESD) component 220-2 comprising diode 226-3 and 226-4 coupled to center tap 211, and inductors 212-1 and 212-3 of y-coil component 210. Inductors 212-1 and 212-3 on signal path 218-2 can be configured to reduce capacitive reactance on signal path 218-2 such that signals sent on signal path 218-2 between transmitter 214 and I/O pad 206 can meet particular bandwidth metrics for the I/O component 204.

FIG. 3 is a flow diagram of a method 340 for reducing transceiver capacitive reactance in accordance with a number of embodiments of the present disclosure. The method as illustrated by the flow diagram 340 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 342, the method can include sending a first signal from a first signal driver of a transceiver (e.g., transmitter 214 of FIG. 2) of a bi-directional I/O component (e.g., I/O component 204 of FIG. 2) to an input/out (I/O) pad (e.g., I/O pad 206 of FIG. 2) of the bi-directional I/O component via a first signal path (e.g., signal path 218-2 of FIG. 2). The method can include sending the first signal by transmitting the first signal via a transmitter of the bi-directional I/O component.

At 344, the method can include sending a second signal from an input/out (I/O) pad (e.g., I/O pad 206 of FIG. 2) of the bi-directional I/O component (e.g., I/O component 204 of FIG. 2) to a second signal driver of the transceiver (e.g., receiver 216 of FIG. 2) of the bi-directional I/O component via a second signal path (e.g., signal path 218-1 of FIG. 2). The method can include sending the second signal by receiving the second signal via a receiver of the bi-directional I/O component.

The method can include controlling capacitive reactance on the first conductive path with a first inductor and a second inductor between the first signal driver of the transceiver and the I/O pad and controlling capacitive reactance on the second conductive path with a third inductor and the second inductor between the I/O pad and the second signal driver of the transceiver.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a first signal driver of a transceiver;
a second signal driver of the transceiver;
an input/output (I/O) pad; and
a y-coil, wherein the y-coil includes a first inductor coupled to the first signal driver of the transceiver, a second inductor coupled to the second signal driver of the transceiver, and a third inductor coupled to the I/O pad.

2. The apparatus of claim 1, wherein a first electrostatic discharge (ESD) component is between the second inductor of the y-coil and the second signal driver of the transceiver.

3. The apparatus of claim 2, wherein the first ESD component includes a first resistor coupled to a first diode and a second diode.

4. The apparatus of claim 1, wherein a termination resistor is between the first inductor of the y-coil and the first signal driver of the transceiver.

5. The apparatus of claim 1, wherein the first inductor is coupled to the first signal driver of the transceiver and a center tap of the y-coil.

6. The apparatus of claim 1, wherein the second inductor is coupled to the second signal driver of the transceiver and a center tap of the y-coil.

7. The apparatus of claim 1, wherein the third inductor is coupled to the I/O pad and a center tap of the y-coil.

8. The apparatus of claim 1, wherein a second electrostatic discharge (ESD) component is coupled to a center tap of the y-coil and wherein the second ESD component includes a third diode and a fourth diode.

9. The apparatus of claim 1, wherein the first signal driver is a transmitter and the second signal driver is a receiver.

10. An apparatus, comprising:
an input/output (I/O) component comprising:
a first signal driver of a transceiver;
a second signal driver of the transceiver; and
an input/output (I/O) pad; and
a y-coil, wherein the y-coil includes a first inductor configured to reduce capacitive reactance on a first conductive path between the I/O pad and the first signal driver of the transceiver and a second inductor configured to reduce capacitive reactance on a second conductive path between the I/O pad and the second signal driver of the transceiver.

11. The apparatus of claim 10, wherein the y-coil includes the first inductor coupled between the first signal driver of the transceiver and a center tap of the y-coil.

12. The apparatus of claim 10, wherein the y-coil includes the second inductor coupled between the second signal driver of the transceiver and a center tap of the y-coil.

13. The apparatus of claim 10, wherein the y-coil includes a third inductor coupled between the I/O pad and a center tap of the y-coil.

14. The apparatus of claim 10, a first electrostatic discharge (ESD) component is between the second inductor of the y-coil and the second signal driver of the transceiver.

15. The apparatus of claim 10, a second electrostatic discharge (ESD) component is coupled to a center tap of the y-coil.

16. The apparatus of claim 10, wherein the first signal driver is a transmitter and the second signal driver is a receiver.

17. A method, comprising:
sending a first signal from a first signal driver of a transceiver of a bi-directional I/O component to an input/out (I/O) pad of the bi-directional I/O component via a first signal path; and
sending a second signal from an input/out (I/O) pad of the bi-directional I/O component to a second signal driver of the transceiver of the bi-directional I/O component via a second signal path.

18. The method of claim 17, further including controlling capacitive reactance on the first conductive path with a first inductor and a second inductor between the first signal driver of the transceiver and the I/O pad.

19. The method of claim 17, further including controlling capacitive reactance on the second conductive path with a third inductor and the second inductor between the I/O pad and the second signal driver of the transceiver.

20. The method of claim 17, wherein sending the first signal includes transmitting the first signal via a transmitter of the bi-directional I/O component and wherein sending the second signal includes receiving the second signal via a receiver of the bi-directional I/O component.
